(19) United States
(12) Patent Application Publication
(10) Pub. No.: US 2018/0136323 A1
(43) Pub. Date: May 17, 2018

(54) RADAR DEVICE

(71) Applicant: HÜBNER GmbH & Co. KG, Kassel (DE)

(72) Inventors: Dimitry POZDNIAKOV, Kassel (DE); Salman RAHMI, Staufenberg (DE); Daniel HÜBSCH, Kassel (DE)

(73) Assignee: HÜBNER GmbH & Co. KG, Kassel (DE)

(21) Appl. No.: 15/573,221

(22) PCT Filed: May 3, 2016
(86) PCT No.: PCT/EP2016/059889

§ 371 Date: Nov. 10, 2017

(30) Foreign Application Priority Data
May 12, 2015 (DE) 10 2015 107 419.2

(51) Int. Cl. G01S 13/34; G01S 7/35

(52) U.S. Cl. CPC G01S 13/34; G01S 7/35

(57) ABSTRACT

An FMCW radar device for determines the distance of an object from an element of the radar device. An FMCW radar device is disclosed having a predetermined time interval for the change in radar frequency of 100 μs or less, a controllable oscillator configured such that while the radar device is operating the radar frequency can be tuned within the predetermined time interval via a tuning bandwidth of at least 4 GHz, and a phase comparator configured such that same provides a phase stabilisation of the generated radar signal for at least 900 frequencies of the radar signal within the tuning bandwidth of the controllable oscillator and within the predetermined time interval.

The present invention relates to a radar device for determining the distance of an object from an element of the radar device, with a phase-stabilized reference oscillator, which is configured such that, during operation of the radar device, it produces and outputs an electrical reference signal in continuous-wave operation with a reference frequency; a frequency synthesizer, which is configured such that, during operation of the radar device, it produces a phase-stabilized radar signal with a radar frequency that changes temporally within a predefined time interval, wherein the frequency synthesizer has a phase comparator, which is configured and arranged such that, during operation of the radar device, a reference signal input receives the reference signal from the reference oscillator, an input signal input receives an input signal and an error signal output outputs an error signal, wherein the error signal has a portion which is proportional to a phase difference between the reference signal and the input signal, a loop filter, which is configured and arranged such that, during operation of the radar device, it receives the error signal from the phase comparator, produces a control signal by applying a filter function to the error signal and outputs the control signal, a controllable oscillator, which is configured and arranged such that, during operation of the radar device, it receives the control signal from the loop filter as a control factor, generates the radar signal and outputs the radar signal, wherein the radar frequency depends on the control signal and wherein the radar frequency is a multiple of the reference frequency, and a frequency divider, which is configured and arranged such that, during operation of the radar device, it receives the radar signal from the controllable oscillator or a signal produced from the radar signal with a frequency which is a higher harmonic of the radar frequency, produces the input signal with an input signal frequency which is equal to the radar frequency divided in a division ratio from the radar signal or from the signal produced from the radar signal and outputs the input signal; a transmitter antenna, which is configured and arranged such that, during operation of the radar device, it receives the radar signal from the controllable oscillator or a signal produced from the radar signal with a frequency which is a higher harmonic of the radar frequency and emits the radar signal or the signal produced from the radar signal; a receiver antenna, which is configured and arranged such that, during operation of the radar device, it receives and outputs the radar signal emitted by the transmitter antenna or the signal produced from the radar signal and emitted by the transmitter antenna; a mixer, which is configured and arranged such that, during operation of the radar device, it receives the radar signal from the controllable oscillator and the radar signal received by the receiver antenna or a signal which was produced from the signal received by the receiver antenna by frequency division, produces an intermediate frequency signal by mixing the signals and outputs the intermediate frequency signal; and an evaluator, which is configured and arranged such that, during operation of the radar device, it receives the intermediate frequency signal from the mixer, determines the frequency of the intermediate frequency signal and, from the frequency of the intermediate frequency signal, calculates a distance between an object that can be arranged in a beam path of the radar signal or of the signal produced from the radar signal between the transmitter antenna and the receiver antenna and reflects the radar signal or the signal produced from the radar signal and the transmitter antenna or the receiver antenna, wherein either the reference oscillator is tunable, with the result that, during operation of the device, it produces and outputs the reference signal with a reference frequency that changes temporally within the predefined time interval and the frequency divider has a constant division ratio or the frequency divider is configured such that, during operation of the device, it has a division ratio that changes temporally within the predefined time interval and the reference oscillator is configured such that, during operation of the device, it produces a reference signal with a constant reference frequency.

The principle of frequency-modulated continuous wave radar (abbreviated to FMCW radar) is known from the state of the art. This principle makes radar operation possible with determination of the direction; and distance between an object and a transmitter or receiver antenna of the radar device with a reasonable expenditure on equipment.

The aim of FMCW radar is to determine the transit time of a radar signal emitted by a transmitter antenna and received by a receiver antenna, and thus the distance between the object and one of the antennae. The distance measurement is based on the fact that the frequency of a mono-frequent, narrow-band radar signal is varied over time. For example, over a time interval, the frequency of the emitted signal increases continuously and linearly vis-à-vis time. If part of the generated radar signal is now used as reference signal and this reference signal is routed directly to the receiver, while the actual radar signal from the transmitter antenna runs, via the object, back to the receiver, antenna and the radar signal received by the receiver antenna is mixed, at the receiver, with the reference signal, then the mixing process generates an intermediate frequency signal. The frequency of the intermediate frequency signal results from the different transit times of reference signal and radar signal. It is important that the transit time of the radar signal is not greater than the predetermined time interval over which the frequency of the emitted radar signal is changed. If the generated intermediate frequency is now determined at the receiver, i.e. behind the mixer, then it is proportional to the distance between the transmitter antenna or the receiver antenna and ah object reflecting the radar signal.

In other words, the time point of the emission of the radar signal within a time interval in which the frequency of the emitted radar signal is varied is frequency-encoded.

In the FMCW radar systems from the state of the art, it has proved to be disadvantageous that either they are suitable for distance measurement of an object that is not moving or is only moving slowly in high resolution or else these systems can detect the distance of a quickly moving object in low resolution.

The object of the present invention, on the other hand, is to provide a radar device which makes it possible to determine the distance between transmitter antenna or receiver antenna and a quickly moving object in high resolution.

At least one of these objects is achieved according to the invention by a radar device for determining the distance of an object from an element of the radar device, with a phase-stabilized reference oscillator, which is configured such that, during operation of the radar device, it produces and outputs an electrical reference signal in continuous-wave operation with a reference frequency; a frequency synthesizer, which is configured such that, during operation of the radar device, it produces a phase-stabilized radar signal with a radar frequency that changes temporally within a predefined time interval, wherein the frequency synthesizer has a phase comparator, which is configured and arranged such that, during operation of the radar device, a reference signal input receives the reference signal from the reference oscillator, an input signal input receives an input signal and an error signal output outputs an error signal, wherein the error signal has a portion which is proportional to a phase difference between the reference signal and the input signal, a loop filter, which is configured and arranged such that, during operation of the radar device, it receives the error signal from the phase comparator, produces a control signal by applying a filter function to the error signal and outputs the control signal, a controllable oscillator, which is configured and arranged such that, during operation of the radar device, it receives the control signal from the loop filter as a control factor, generates the radar signal and outputs the radar signal, wherein the radar frequency depends on the control signal and wherein the radar frequency is a multiple of the reference frequency, and a frequency divider, which is configured and arranged such that, during operation of the radar device, it receives the radar signal from the controllable oscillator or a signal produced from the radar signal with a frequency which is a higher harmonic of the radar frequency, produces the input signal with an input signal frequency which is equal to the radar frequency divided in a division ratio from the radar signal or from the signal produced from the radar signal and outputs the input signal; a transmitter antenna, which is configured and arranged such that, during operation of the radar device, it receives the radar signal from the controllable oscillator or a signal produced from the radar signal with a frequency which is a higher harmonic of the radar frequency and emits the radar signal or the signal produced from the radar signal; a receiver antenna, which is configured and arranged such that, during operation of the radar device, it receives and outputs the radar signal emitted by the transmitter antenna or the signal produced from the radar signal and emitted by the transmitter antenna; a mixer, which is configured and arranged such that, during operation of the radar device, it receives the radar signal from the controllable oscillator and the radar signal received by the receiver antenna or a signal which was produced from the signal received by the receiver antenna by frequency division, produces an intermediate frequency signal by mixing the signals and outputs the intermediate frequency signal; and an evaluator, which is configured and arranged such that, during operation of the radar device, it receives the intermediate frequency signal from the mixer, determines the frequency of the intermediate frequency signal and, from the frequency of the intermediate frequency signal, calculates a distance between an object that can be arranged in a beam path of the radar signal or of the signal produced from the radar signal between the transmitter antenna and the receiver antenna (5) and reflects the radar signal or the signal produced from the radar signal and the transmitter antenna or the receiver antenna, wherein either the reference oscillator is tunable, with the result that, during operation of the device, it produces and outputs the reference signal with a reference frequency that changes temporally within the predefined time interval and the frequency divider has a constant division ratio or the frequency divider is configured such that, during operation of the device, it has a division ratio that changes temporally within the predefined time interval and the reference oscillator is configured such that, during operation of the device, it produces a reference signal with a constant reference frequency, wherein the predefined time interval is 100 μs or less, the controllable oscillator is configured such that, during operation of the radar device, the radar frequency is tunable within the predefined time interval over a tuning bandwidth of at least 4 GHz, and the phase comparator is configured such that it provides a phase stabilization of the produced radar signal at least at 900 frequencies of the radar signal within the tuning bandwidth of the controllable oscillator and within the predefined time interval.

A fundamental requirement of FMCW radar systems for distance measurement is that the predefined time interval over which the frequency of the radar signal is changed is greater than the maximum duration which the radar signal or a signal produced therefrom coming from the generating oscillator via the transmitter antenna, the object and the receiver antenna to the mixer requires.

The distance covered by or the transit time of the radar signal or a signal produced therefrom between the transmitter antenna and the receiver antenna is proportional to the intermediate frequency between a part of the radar signal guided to the mixer directly from the controllable oscillator and a part of the radar signal emitted by an antenna, reflected by an object and received by an antenna and then routed to the mixer, or a signal generated therefrom. The difference frequency, i.e. the frequency of the intermediate frequency signal, results because, during the transit time of the radar signal or of the signal produced therefrom, the radar frequency of the radar signal currently generated by the controllable oscillator and guided directly to the mixer has increased or decreased by precisely the intermediate frequency.

It has been shown that, when it is desired to detect quickly moving objects and to determine their distance from the transmitter antenna or receiver antenna with sufficient precision, in addition the predefined time interval within which the radar frequency of the radar signal is changed over the tuning bandwidth must be very small, with the result that even a very quickly moving object is to be observed as if stationary in this predefined time interval. The shorter the predefined time interval in which the radar frequency is varied over the tuning bandwidth is, the more often this variation can additionally be repeated within a second and the greater the maximum sampling frequency with which the distance of the object can be detected is. In the case of a predefined time interval in which the radar frequency is varied over the tuning bandwidth of 100 μs, the maximum sampling frequency is 10 kHz.

In order to be able to provide the necessary spatial resolution in the propagation direction of the signal emitted by the transmitter antenna to determine the distance of such a quickly moving object from the transmitter antenna or the receiver antenna, at the same time it is additionally necessary to comply with a range of further boundary conditions.

For one thing, a tuning bandwidth of the radar signal produced by the controllable oscillator of at least 4 GHz within the predefined time interval is necessary. It follows from this that, in a first embodiment, the reference oscillator must be configured such that, within the predefined time interval, the reference frequency is tunable over a tuning bandwidth which is at least equal to an n-th part of the tuning bandwidth of the controllable oscillator, wherein n is then the factor by which the radar frequency is greater than the reference frequency. In this embodiment, the division ratio in which the radar frequency is divided in the frequency divider in order to produce the input signal is constant and is likewise 1/n. In an embodiment, the factor n is a whole number. In an embodiment, the change of the radar frequency produced by the controllable oscillator within the predefined time interval over the tuning bandwidth takes place linearly over time, i.e. as the time increases the reference frequency of the reference signal increases or decreases proportionally to the time elapsed within the time interval.

In a second embodiment, as an alternative to the previously represented embodiment, the reference frequency is constant. In such an embodiment, instead, the division ratio of the frequency divider is varied over time during the predefined time interval. The error voltage of the frequency comparator in this embodiment comprises, in addition to the portion which is proportional to the phase difference between reference signal and input signal, a constant offset which predefines, as control signal of the controllable oscillator, its radar frequency. In an embodiment, the change of the division ratio of the frequency divider within the predefined time interval takes place linearly over time. In order to satisfy the high demands on the tunability of the controllable oscillator as well as the lock time at the individual frequencies within the tuning bandwidth of the controllable oscillator, this embodiment seems to offer advantages.

In addition, the phase comparator must be capable of stabilizing the radar signal at least at 1000 frequencies during the tuning of the frequency of the radar signal within the predefined time interval, in particular within 100 μs or less, over the tuning bandwidth of the controllable oscillator, in particular over a tuning bandwidth of at least 4 GHz.

In an embodiment of the invention, the radar signal is stabilized at least at 2000 frequencies, preferably at least at 4000 and particularly preferably at least at 5000 frequencies, during the tuning of the frequency of the radar signal within the predefined time interval over the tuning bandwidth. These frequencies or frequency points are preferably distributed equidistant over the tuning bandwidth. In other words, the phase comparator must have a sufficiently short lock time.

It is understood that the radar device according to the invention can be realized with analogue technology in an embodiment. There the individual elements are interconnected or electrically connected to each other as discrete components. Alternatively, in an embodiment, the radar device according to the invention can be realized completely or partially with digital technology. This presupposes the use of corresponding digital-to-analogue converters and analogue-to-digital converters at the corresponding locations in the device, as is known from the state of the art in various ways.

It has been shown that, even when the individual components, i.e. the reference oscillator, the phase comparator or and the oscillator or the frequency divider, can satisfy the necessary parameters, the predefined time interval for tuning the radar signal over the full tuning bandwidth is so short that in an embodiment of the invention measurements can be carried out with the desired precision only when the lines for the signals are kept sufficiently short. In this way, among other things, the effect of parasitic capacities on the signals transmitted via the lines can be minimized. Otherwise, the required parameters of the radar device possibly cannot be satisfied.

In an embodiment, therefore, a line for the control signal between the loop filter and the controllable oscillator has a length of less than 1 cm. In a further embodiment of the invention, the length of the line for the control signal between the loop filter and the controllable oscillator is smaller than 8mm, preferably smaller than 5 mm and particularly preferably smaller than 3 mm. In an embodiment of the invention realized with digital technology, in which the loop filter is implemented in a first microchip, while the controllable oscillator is implemented in a second microchip, the length claimed here of the line for the control signal between the loop filter and the controllable oscillator is measured between the pins of the two chips.

In another embodiment of the invention, a line for the error signal between the phase comparator and the loop filter and a line for the control signal between the loop filter and the controllable oscillator together have a length of less than 1 cm. In an embodiment of the invention, the total length of the line for the error signal between the phase comparator and the loop filter and the line for the control signal between the loop filter and the controllable oscillator is smaller than 8 mm, preferably smaller than 5 mm and particularly preferably smaller than 3 mm.

In an embodiment of the invention, the radar signal produced by the controllable oscillator with the radar frequency is emitted by the transmitter antenna and received by the receiver antenna. It is understood that, for the receiving and for the evaluation in this case, a part of the radar signal is sent to the mixer directly by the controllable oscillator and the radar signal received by the receiver antenna is likewise sent to the mixer.

In an alternative embodiment, from the radar signal produced by the controllable oscillator with the radar frequency, a signal with a frequency which is equal to a higher harmonic of the radar frequency is produced by frequency multiplication in suitable non-linear electronic components; this signal produced from the radar signal is then fed into the transmitter antenna, emitted and received by the receiver antenna. Higher emitted frequencies make a higher resolution possible in a direction perpendicular to the propagation direction of the emitted radiation. It is understood that, in such an embodiment, the signal received by the receiver antenna with the higher harmonic of the radar frequency is converted, by division of the frequency, into a signal with the radar frequency, before this signal is sent to the mixer and mixed with the radar signal from the controllable oscillator.

Embodiments which emit and receive a signal generated from the radar signal with a higher harmonic of the radar frequency can, in an embodiment, additionally have an alternative design of the control loop of the frequency synthesizer. Instead of feeding the radar signal produced by the controllable oscillator into the phase comparator as input signal via the frequency divider, in such an embodiment a part of the signal produced from the radar signal with the higher harmonic of the radar frequency can be fed into the frequency divider and thus close the control loop. Such an embodiment has the advantage that it balances out amplitude fluctuations which are introduced by the frequency multiplication behind the controllable oscillator.

The basic structure of the radar device according to the present invention is a frequency-stabilized and frequency-tunable frequency synthesizer, as is known from the state of the art in various embodiments.

A phase-stabilized, tunable reference oscillator provides an electrical reference signal in continuous-wave operation, i.e. a mono-frequent reference signal with a reference frequency.

The reference oscillator produces the reference signal at a reference frequency at which electrical signals can be produced very stably. In an embodiment of the invention, the reference signal is a sinusoidal signal with a frequency in a frequency range from 50 MHz to 150 MHz, preferably at 100 MHz. This applies in particular to embodiments with a reference frequency that is constant over time.

In an embodiment of the invention, the temporal change of the reference frequency of the reference signal or the temporal change of the division ratio of the frequency divider and thus also of the radar signal takes place periodically, i.e. after one cycle of the frequency change within the predefined time interval the frequency tuning begins again. The frequency spectrum of an embodiment looks like a sawtooth signal, wherein dead times can be provided between the periodically repeated rises or modulations of the frequency vis-á-vis time. In an embodiment of the invention, the reference oscillator is configured such that a phase noise of the reference signal is less than −170 dBc/Hz, preferably less than −150 dBc/Hz and particularly preferably less than −100 dBc/Hz, and preferably at a reference frequency of 100 MHz.

The frequency synthesizer itself comprises a phase comparator which, at its reference signal input, receives the reference signal from the reference oscillator, compares the phase of the reference signal with an input signal received at the input signal input of the phase comparator and outputs an error signal at the error signal output, which is proportional to a phase difference between the reference signal and the input signal. In this way, the radar signal to be produced can be locked or phase-stabilized to the reference signal.

A loop filter is configured and arranged such that it receives the error signal of the phase comparator, produces a control signal by applying a filter function to the error signal and outputs the control signal.

A central element of the frequency synthesizer is the controllable oscillator. The controllable oscillator is preferably a voltage-controlled oscillator (or VCO). The frequency of the radar radiation produced by the controllable oscillator depends on the control signal, wherein the radar frequency of the radar signal produced by the controllable oscillator is a multiple of the reference frequency. In an embodiment of the invention, the radar frequency is a whole-number multiple of the reference frequency.

For feedback into the phase comparator, a part of the radar signal generated by the controllable oscillator or of a signal generated from the radar signal by frequency multiplication is used, wherein the radar signal or the signal generated therefrom is first guided through a frequency divider in order to generate, from the radar signal, the input signal with an input signal frequency for the input signal input of the phase comparator.

In this way, a control loop is provided for the frequency or phase stabilization of the radar signal generated by the controllable oscillator or of the frequency-multiplied signal derived therefrom.

In an embodiment of the invention, the radar frequency lies in a range from 5 GHz to 600 GHz, preferably in a range from 20 GHz to 100 GHz.

In a further embodiment, the controllable oscillator and the reference oscillator or the frequency divider are configured and designed such that, during operation of the radar device, the controllable oscillator changes the radar frequency linearly over time within a predefined time interval of 80 μs or less, preferably of 50 μs or less and particularly preferably of 30 μs or less over an assigned frequency range, namely the tuning bandwidth. In an embodiment of the invention, the tuning bandwidth of the controllable oscillator is at least 8 GHz, preferably at least 10 GHz and particularly preferably at least 50 GHz. In an embodiment of the invention, the predefined time interval is 100 μs or less, wherein the tuning bandwidth is at least 8 GHz, preferably at least 10 GHz and particularly preferably at least 50 GHz. In an embodiment of the invention, the predefined time interval is 80 μs or less, wherein the tuning bandwidth is at least 8 GHz, preferably at least 10 GHz and particularly preferably at least 50 GHz. In an embodiment of the invention, the predefined time interval is 50 μs or less, wherein the tuning bandwidth is at least 8 GHz, preferably at least 10 GHz and particularly preferably at least 50 GHz. In an embodiment of the invention, the predefined time interval is 30 μs or less, wherein the tuning bandwidth is at least 8 GHz, preferably at least 10 GHz and particularly preferably at least 50 GHz.

While, in one embodiment of the invention, the transmitter antenna, which is connected to the controllable oscillator or a frequency multiplier such that it emits the signal, and the receiver antenna can be two components separated from each other (bistatic radar), in an embodiment of the invention the transmitter antenna and the receiver antenna are identical (monostatic radar).

The realization of a monostatic radar presupposes that it is possible to couple the radar signal generated by the controllable oscillator into the antenna for emission and to route the radar signal received by the antenna as receiver antenna to the mixer. There it is necessary to prevent direct crosstalk, i.e. a direct signal guiding, of the radar signal from the controllable oscillator, without emission and receiving by the antenna, to the mixer. In addition, it must be guaranteed that the radar signal received by the antenna is routed completely to the mixer. For this purpose, in an embodiment of the invention, a circulator is provided which is configured and arranged such that, during operation of the radar device, it receives the radar signal from the controllable oscillator and, for emission, outputs it to the antenna, receives the radar signal received by the antenna and outputs it to the mixer, and prevents a dire& output, i.e. crosstalk, of the radar signal from the controllable oscillator to the mixer.

The extremely high demands on the tuning bandwidth of the radar signal in the very short predefined time interval call for a substantial optimization both of the signal routing behind the controllable oscillator and during the signal processing.

In an embodiment of the invention, therefore, between an input receiving the radar signal from the controllable oscillator and an output for the radar signal received by the antenna, the circulator has an isolation of al least −38 dB and preferably of at least −40 dB.

In a further embodiment of the invention, the circulator is a dual circulator.

In an embodiment of the invention, the transmitter antenna or the receiver antenna are designed such that they have a minimum reflectance, i.e. the signal loss during the transition of the radar signal into the antenna or out of the antenna is as small as possible. For this, in an embodiment of the invention, the transmitter antenna or the receiver antenna has an S11 parameter of −10 dB or less, preferably of −15 dB or less, over the tuning bandwidth of the controllable oscillator or the tuning bandwidth of a signal produced therefrom by frequency multiplication.

It is particularly expedient if, in an embodiment of the radar device according to the present invention, both quadrature components of the radar signal can be measured and evaluated at the same time.

For this, in an embodiment of the invention, the radar device has a first and a second mixer and a phase shifter, wherein the first mixer is configured and arranged such that, during operation of the radar device, it receives the radar signal from the oscillator and the radar signal received by the receiver antenna or the signal which was produced from the signal received by the receiver antenna by frequency division, produces and outputs a first intermediate frequency signal by mixing the signals with each other, wherein the phase shifter is configured and arranged such that, during operation of the radar device, it receives the radar signal from the oscillator, introduces a phase shift of 90° into the radar signal from the oscillator relative to the radar signal from the oscillator received by the first mixer and outputs a phase-shifted radar signal, and wherein the second mixer is configured and arranged such that, during operation of the radar device, it receives the phase-shifted radar signal from the phase shifter and the radar signal received by the receiver antenna or the signal which was produced from the signal received by the receiver antenna by frequency division, produces and outputs a second intermediate frequency signal by mixing the signals with each other, and wherein the evaluator is configured and arranged such that, during operation of the radar device, it receives the first and the second intermediate frequency signal from the first and the second mixer, evaluates them and determines a distance between an object that can be arranged in a beam path of the radar signal between the transmitter antenna and the receiver antenna and reflects the radar radiation and the transmitter antenna and/or the receiver antenna.

The signal processing of the intermediate frequency signal or intermediate frequency signals behind the mixer or mixers requires a high level of attention because of the severe demands on the tunability of the radar signal.

The radar device in an embodiment therefore has a filter, wherein the filter is configured and arranged such that it receives the intermediate frequency radiation from the mixer and outputs a filtered intermediate frequency radiation. In an embodiment of the invention, this filter is a bandpass filter. The bandpass filter in an embodiment is configured such that it filters a direct-current voltage portion as well as higher-frequency repeating spectra out of the intermediate frequency signal. In an embodiment, the upper cutoff frequency of the bandpass filter is equal to half the sampling frequency and the lower cutoff frequency is equal to or smaller than 0.1 times half the sampling frequency.

In an embodiment of the invention, the radar device additionally has an amplifier, wherein the amplifier is configured and arranged such that the amplifier receives the intermediate frequency signal from the mixer and outputs an amplified intermediate frequency signal. In this way, the signal level is adapted to the demands of the subsequent evaluator. In particular, an adaptation of the signal level to a following analogue-to-digital converter takes place.

The evaluator in an embodiment comprises a data processing device with a processor.

The evaluation of the intermediate frequency signal or signals usefully takes place digitally in an embodiment. For this, in an embodiment of the invention, the evaluator comprises an analogue-to-digital converter which is configured and arranged such that it converts the intermediate frequency signal into a digital signal for further digital processing. In order to satisfy the high demands on the required spatial resolution of the radar device, in an embodiment the analogue-to-digital converter has a bit depth of at least 14 bits, preferably of at least 16 bits. In an embodiment of the present invention, to determine the frequency of the intermediate frequency signal in the evaluator, a Fourier transform is applied to the intermediate frequency signal. If the frequency of the intermediate frequency signal is known, the distance between an object and the transmitter antenna or the receiver antenna can be calculated therefrom and from the knowledge of the frequency change vis-à-vis time during the emission of the radar signal.

In an embodiment of the invention, in each case the maximum of the amplitude spectrum is determined, wherein the frequency belonging to the maximum of the amplitude is used as intermediate frequency in the calculation for determining the distance of the object from the transmitter antenna or the receiver antenna.

In an embodiment of the invention, instead of the amplitude spectrum obtained by the Fourier transform of the intermediate frequency signal or in addition to it, the phase spectrum is evaluated and the distance between an object and the transmitter antenna or the receiver antenna is calculated therefrom.

The phase spectrum of the intermediate frequency signal obtained by Fourier transform proves to be much more resilient to noise and undesired reflections than the amplitude spectrum is. The phase alters periodically and in a linear manner from −2 π to +2 π with the distance of the object from the transmitter antenna or the receiver antenna between a distance 0 and a maximum distance.

As mentioned at the beginning, the radar device according to the present invention is suitable in particular for detecting a distance between a quickly moving object and an element of the radar device with high Precision. Therefore, in an embodiment of the invention, a radar device such as was described previously with reference to embodiments thereof is used to determine a distance of a moving part from a stationary housing, wherein the moving part is received in the housing and wherein an element of the radar device is arranged in the housing.

There are a range of uses for such distance measurements. For example, the movement of a moving piston in a cylinder can be monitored. In such an embodiment, the piston is the moving part and the cylinder is the housing within the meaning of the present application. With the device according to the invention, vibrations of a part in a housing can also be detected.

However, high speeds are achieved in particular in arrangements with rotating rotors. There the rotor forms a moving part within the meaning of the present application. It is necessary to maintain a defined distance between the rotor or an element thereof and a housing, preferably surrounding the rotor in an annular manner. Examples of such arrangements consisting of a rotor and a housing are pumps and electric motors.

Therefore, in one embodiment of the invention, a radar device such as was described previously with reference to embodiments thereof, is used to determine a distance of a rotating rotor from a stationary housing.

An element of the radar device is expediently arranged in the housing, with the result that the distance between the rotor and the housing can be derived from the distance between the rotor and the element of the radar device. Even if the latter is much more complex in terms of design, in an embodiment an element of the radar device can alternatively be arranged in the rotor, with the result that the distance between rotor and housing can be derived from the distance between an element of the radar device in the rotor and the housing.

In an embodiment, the distance to be determined between the rotor and the housing is the radial extent of a gap between the rotor and the housing.

Further advantages, features and possible uses of the present invention are illustrated with reference to the attached figures of an embodiment and the associated description.

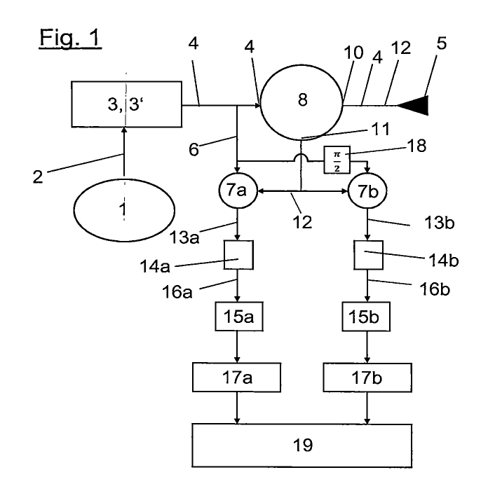

FIG. 1 shows a block diagram of an embodiment of the radar device according to the intention.

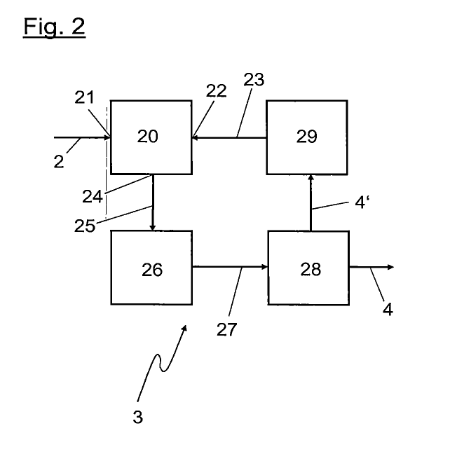

FIG. 2 shows a block diagram of a first embodiment of the frequency synthesizer of the radar device from FIG. 1.

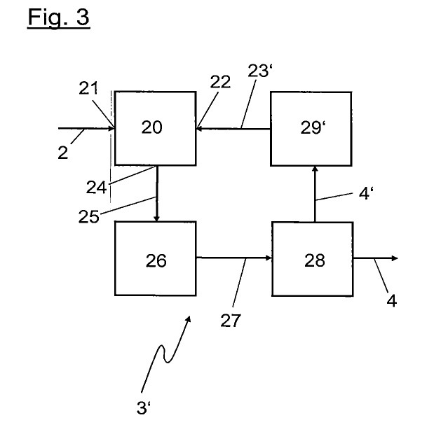

FIG. 3 shows a block diagram of a second embodiment of the frequency synthesizer of the radar device from FIG. 1.

In the figures identical elements are given identical reference numbers.

FIG. 1 shows schematically, a radar device according to the invention in the form of an FMCW radar, which, in real-time operation, makes it possible to detect the distance of an object from an element of the radar device, namely the antenna, and to detect changes in the distance of this object.

The principle of FMCW radar used here makes it possible to determine the distance of an object from the radar device with the aid of the evaluation of a reflected echo of the emitted radar signal with a comparatively low expenditure on hardware.

The advantage of the radar device according to the invention shown here is that it makes it possible to determine the distance of the object from the radar device in the micrometre range, wherein the position of the object can change, and still be detected, on a timescale of less than one millisecond.

The system represented has an average error of ±4 μm.

In order to be able to satisfy these demands on the precision of the measurement as well as on the possibility of measuring a quick change in the distance of the object in real time, the radar device from FIG. 1 has the following architecture.

The reference oscillator 1 produces a reference signal 2, the reference frequency of which, depending on the choice of the frequency synthesizer 3, is either varied within the predefined time interval of 50 μs in 5000 equidistant steps between 3 GHz and 3.5 GHz (embodiment of the frequency synthesizer according to FIG. 2) or which is constantly 100 MHz (embodiment of the frequency synthesizer according to FIG. 3). The reference signal has a phase noise of less than −150 dBc/Hz. This low-fluctuation reference signal 2 is sent to a phase-stabilized, low-noise frequency synthesizer 3, 3′.

The structure of first embodiment of the frequency-stabilized frequency synthesizer 3 is shown in detail in FIG. 2

The reference signal 2 of the reference oscillator 1 is sent to a phase comparator 20. The latter serves to stabilize the phase of the radar signal 4, 4′ produced and emitted by the frequency synthesizer. The radar frequency 4 generated by the frequency synthesizer 3 therefore also immediately follows changes of the reference frequency of the reference signal 2 generated by the reference oscillator 1.

In the embodiment represented, the radar frequency of the radar signal 4, 4′ changes within a time interval of 50 μs over a tuning bandwidth of 4 GHz, i.e. from 24 GHz to 28 GHz. The frequency modulation has the shape of a sawtooth, with the result that one rise of the frequency from 24 GHz 10 to 28 GHz is immediately followed by the next rise. The predetermined time interval over which the frequency of the radar signal 4 changes thus also determines the maximum sampling frequency (also called the maximum sampling rate or pulse repetition frequency) with which successive measurements can take place.

The phase comparator 20 receives, at its reference signal input 21, the reference signal 2 and, at its input signal input 22, an input signal 23. The source of the input signal 23 will be described in detail in the following.

The phase comparator 20 outputs, at its error signal output 24, an error signal 25 which is proportional to the phase difference between the reference signal 2 and the input signal 23. This error signal 25 is filtered in a loop filter 26. The loop filter 26, in the form of a low-pass filter, produces a control signal 27 from the error signal 25. The control signal 27 is sent to the voltage input of a controllable oscillator, here a voltage-controlled oscillator or VCO 28.

The controllable oscillator 28 generates the radar signal 4, 4′ and outputs this, wherein the radar frequency depends on the level of the control signal 27 and wherein the radar frequency has eight times the frequency of the reference signal 2. A part of the radar signal 4′ generated by the VCO is converted into the input signal 23 of the phase comparator 20 via a frequency divider 29, which divides the frequency of the radar signal 4′ by n.

In order to be able to satisfy the demands of the frequency tuning over a tuning bandwidth of 4 GHz within the predefined frequency interval of 50 μs, the phase comparator 20 must have an extremely short lock time. In the embodiment represented, the phase comparator 20 has a lock time which is so short that it stabilizes the VCO 27 at 5000 different and equidistant frequencies from the 35 frequency interval or the tuning bandwidth between 24 GHz and 28 GHz within the predetermined time interval of 50 μs.

The structure If an alternative embodiment of the frequency-stabilized frequency synthesizer 3′ is shown in detail in FIG. 2.

The reference signal 2 of the reference oscillator 1 with a constant reference frequency of 100 MHz is sent to a phase comparator 20. The latter serves to stabilize the phase of the radar signal 4, 4′ produced and emitted by the frequency synthesizer. As previously, in the embodiment from FIG. 3, the radar frequency of the radar signal 4, 4′ also changes within a time interval of 50 μs over a tuning bandwidth of 4 GHz, i.e. from 24 GHz to 28 GHz. The frequency modulation has the shape of a sawtooth, with the result that one rise of the frequency from 24 GHz to 28 GHz is immediately followed by the next rise.

The phase comparator 20 receives, at its reference signal input 21, the reference signal 2 and, at its input signal input 22, an input signal 23′. The source of the input signal 23′ will be described in detail in the following.

The phase comparator 20 outputs, at its error signal output 24, an error signal 25 which has a portion which is proportional to the phase difference between the reference signal 2 and the input signal 23′. However, the error signal additionally has a fixed voltage offset, which sets the radar frequency of the VCO 28. This error signal 25 is filtered in a loop filter 26. The loop filter 26, in the form of a low-pass filter, produces a control signal 27 from the error signal 25.

A part of the radar signal 4′ generated by the VCO 28 is converted into the input signal 23′ of the phase comparator 20 via a frequency divider 29′, which divides the frequency of the radar signal 4′ in a division ratio. In contrast to the frequency divider 29 of the embodiment from FIG. 2, the division ratio of the frequency divider 29′ from FIG. 3 varies linearly over time over the predetermined time interval. In principle, the frequency divider 29′ can also be split onto two discrete elements, of which one has a fixed division ratio and the other has a variable division ratio.

The division ratio adopts 5000 different discrete values distributed equidistantly between a minimum and a maximum division ratio. In this way, the frequency of the input signal 22′ output by the frequency divider 29′ likewise changes linearly over time over the predetermined time interval. The error signal 26 produced by the phase comparator 20, depending on the frequency difference between the reference signal 2 and the Input signal 23′, has linearly increasing values, which lead to an increase in the radar frequency of the radar signal 4 likewise over the predetermined time interval.

In both embodiments of the frequency synthesizers 3, 3′ from FIGS. 2 and 3, the total length of the line for the error signal 25 between the phase comparator 20 and the loop filter 26 and the line for the control signal 27 between the loop filter 26 and the controllable oscillator 28 together is 5 mm.

The output signal of the frequency synthesizers 3, 3′ in both embodiments of FIGS. 2 and 3 is the radar signal 4, as it is also designated in FIG. 1. This radar signal 4 is, for the most part, emitted by the antenna 5. However, a smaller part 6 of the radar signal 4 is sent to the mixers 7a, 7b of the receiver as a reference.

The part of the radar signal 4 not guided directly to the mixers 7a, 7b passes through a dual circulator 8. The latter makes a signal guiding of the radar signal 4 from the input port 9 of the circulator 8 to its first output port 10 possible and, at the same time, with an isolation of more than −38 dB, prevents crosstalk of the radar signal 4 from the input port 9 to a second output port 11 of the circulator 8.

In addition, the circulator 8 ensures a routing of the radar signal reflected by an object back to the antenna 5 into the second output port 11 of the isolator 8, This reflected radar signal is provided with the reference number 12 in FIG. 1. The antenna 5 transfers the radar signal to the scenario i.e. it illuminates the object. In order to minimize disruptive reflections during the transition of the radar signal 4 to the antenna 5, the antenna 5 has an S11 parameter of less than −15 dB over the entire tuning bandwidth of the controllable oscillator 28. In addition, the progression of the 611 parameter over the entire tuning bandwidth of the controllable oscillator 28 is flat, in order to avoid resonances in the antenna 5.

The radar signal 12 reflected back by an object is again coupled into the system by the antenna 5 and routed to the mixers 7a, 7b via the dual circulator 8. The two mixers 7a, 7b serve to detect, at the same time, the quadrature components of the radar signal 12 reflected by an object. For this, the reference signal 6 which is sent to the second mixer 7b is phase-shifted with the aid of a phase shifter 18 by 90° relative to the reference signal 6 which is sent to the first mixer 7a.

The mixers 7a, 7b produce a first and a second intermediate frequency signal 13a and 13b respectively. The frequency of the first and of the second intermediate frequency signal 13a and 13b respective y is equal to the frequency shift between the reflected radar signals 12 striking the respective mixer 7a, 7b at the same time and the reference signal 6.

The intermediate frequency signals 13a, 13b produced in the two mixers 7a, 7b are filtered with the aid of two filters 14a, 14b respectively, wherein the higher-frequency repeating spectra as well as direct-current voltage portions are suppressed. The amplifiers 15a, 15b connected downstream of the filters adapt the signal levels of the filtered intermediate frequency signals 16a, 16b to the demands of the following analogue-to-digital converters 17a, 17b of the evaluator 19. The evaluator 19 additionally comprises a microprocessor.

Behind the two analogue-to-digital converters 17a, 17b, the further signal evaluation takes place, computer-based, in digital form. In order to be able to cover a high dynamic range, the analogue-to-digital converters 17a, 17b have a bit depth of 14 bits.

The digitalized time-dependent quadrature components (I(t)- and Q(t)) of the intermediate frequency signals 16a, 16b are combined into a complex time-dependent signal s(t)=I(t)+j*Q(t).

The path R from the antenna to the reflecting object and back can in principle be determined according to the following relationship:

$$R = \frac{{c}_{0} \vert Δ f \vert}{2 ( df / dt )}$$

wherein c₀ is the light velocity, Δf is the measured intermediate frequency and df/dt is the frequency deviation per time unit, i.e. is the tuning bandwidth divided by the predefined time interval.

For the signal evaluation, in the embodiment shown, a Fourier transform with 16 bits is applied to the complex tine-dependent signal s(t), with the result that the amplitude and phase spectra after the Fourier transform have a maximum number of supporting points with a minimum frequency spacing between the supporting points. In the present embodiment, the phase spectrum of the Fourier transform is evaluated. Because of the high resolution of the Fourier transform used, the maximum phase in the spectrum already shifts in the case of minimum changes in distance.

The frequency belonging to a maximum of the phase is determined as the frequency of the intermediate frequency signal 13a, 13b and the distance of the object from the antenna 5 is calculated from this intermediate frequency. The phase varies over the predefined time interval from −pi to +pi. The evaluation of the phase spectrum is much more resilient and much more precise than an evaluation of the amplitude spectrum because of the phase stabilization realized here.

For the purposes of the original disclosure, it is pointed out that all features, as revealed to a person skilled in the art by the present description, the drawings or the claims, even if they have been described specifically only in connection with particular further features, can be combined, both individually and in any desired combination, with others of the features or groups of features disclosed here, unless this has been explicitly ruled out or technical circumstances make such combinations impossible or pointless. The comprehensive, precise representation of all conceivable combinations of features is dispensed with here only for the sake of brevity and readability of the description.

While the invention has been represented and described in detail in the drawings and the preceding description, this representation and description is effected merely by way of example and is not considered as limiting the scope of protection defined by claims. The invention is not limited to the embodiments disclosed.

Modifications of the disclosed embodiments are obvious to a person skilled in the art from the drawings, the description and the attached claims. In the claims, the word “have” does not rule out other elements or steps, and the indefinite article “a” or “an” does not rule out a plural number. The mere fact that particular features are claimed in different claims does not rule out the combination thereof. Reference numbers in the claims are not considered as limiting the scope of protection.

### REFERENCE NUMBERS

1 reference oscillator

2 reference signal

3, 3′ frequency synthesizer

4 radar signal

5 antenna

6 smaller part of the radar signal as reference signal

7a, 7b mixer

8 circulator

9 input port of the circulator 8

10 first output port of the circulator 8

11 second output port of the circulator 8

12 radar signal reflected back by an object

13a, 13b intermediate frequency signal

14a, 14b filter

15a, 15b ID amplifier

16a, 16b filtered intermediate frequency signal

17a, 17b analogue-to-digital converter

18 phase shifter

19 evaluator

20 phase comparator

21 reference signal input

22 input signal input

23, 23′ input signal.

24 error signal output

25 error signal

26 loop filter

27 control signal

28 VCO

29, 29′ frequency divider

1. A radar device for determining the distance of an object from an element of the radar device, with
a phase-stabilized reference oscillator, which is configured such that, during operation of the radar device, it produces and outputs an electrical reference signal in continuous-wave operation with a reference frequency;
a frequency synthesizer, which is configured such that, during operation of the radar device, it produces a phase-stabilized radar signal with a radar frequency that changes temporally within a predefined time interval, wherein the frequency synthesizer has
a phase comparator, which is configured and arranged such that, during operation of the radar device, a reference signal input receives the reference signal from the reference oscillator, an input signal input receives an input signal and an error signal output outputs an error signal, wherein the error signal has a portion which is proportional to a phase difference between the reference signal and the input signal,
a loop filter, which is configured and arranged such that, during operation of the radar device, it receives the error signal from the phase comparator, produces a control signal by applying a filter function to the error signal and outputs the control signal,
a controllable oscillator, which is configured and arranged such that, during operation of the radar device, it receives the control signal from the loop filter as a control factor, generates the radar signal and outputs the radar signal, wherein the radar frequency depends on the control signal and wherein the radar frequency is a multiple of the reference frequency, and
a frequency divider, which is configured and arranged such that, during operation of the radar device, it receives the radar signal from the controllable oscillator or a signal produced from the radar signal with a frequency which is a higher harmonic of the radar frequency, produces the input signal with an input signal frequency which is equal to the radar frequency divided in a division ratio from the radar signal or from the signal produced from the radar signal and outputs the input signal;
a transmitter antenna, which is configured and arranged such that, during operation of the radar device, it receives the radar signal from the controllable oscillator or a signal produced from the radar signal with a frequency which is a higher harmonic of the radar frequency and emits the radar signal or the signal produced from the radar signal;
a receiver antenna, which is configured and arranged such that, during operation of the radar device, it receives and outputs the radar signal emitted by the transmitter antenna or the signal produced from the radar signal and emitted by the transmitter antenna;
a mixer, which is configured and arranged such that, during operation of the radar device, it receives the radar signal from the controllable oscillator and the radar signal received by the receiver antenna or a signal which was produced from the signal received by the receiver antenna by frequency division, produces an intermediate frequency signal by mixing the signals and outputs the intermediate frequency signal; and
an evaluator, which is configured and arranged such that, during operation of the radar device, it receives the intermediate frequency signal from the mixer, determines the frequency of the intermediate frequency signal and, from the frequency of the intermediate frequency signal, calculates a distance between an object that can be arranged in a beam path of the radar signal or of the signal produced from the radar signal between the transmitter antenna and the receiver antenna and reflects the radar signal or the signal produced from the radar signal and the transmitter antenna or the receiver antenna,
wherein either the reference oscillator is tunable, with the result that, during operation of the device, it produces and outputs the reference signal with a reference frequency that changes temporally within the predefined time interval and the frequency divider has a constant division ratio or the frequency divider is configured such that, during operation of the device, it has a division ratio that changes temporally within the predefined time interval and the reference oscillator is configured such that, during operation of the device, it produces a reference signal with a constant reference frequency,
wherein
the predefined time interval is 100 μs or less,
the controllable oscillator is configured such that, during operation of the radar device, the radar frequency is tunable within the predefined time interval over a tuning bandwidth of at least 4 GHz and
the phase comparator is configured such that it provides a phase stabilization of the produced radar signal at least at 900 frequencies of the radar signal within the tuning bandwidth of the controllable oscillator and within the predefined time interval.

2. The radar device according to claim 1, wherein the reference oscillator is configured such that the phase noise of the reference signal is less than −160 dBc/Hz.

3. The radar device according to claim 1, wherein the controllable oscillator is configured and designed such that, during operation of the radar device, it changes the radar frequency linearly over time within the predefined time interval of 80 μs or less over a tuning bandwidth of at least 8 GHz.

4. The radar device according to claim 1, wherein the transmitter antenna and the receiver antenna are implemented by one and the same antenna, wherein the radar device has a circulator, which is configured and arranged such that, during operation of the radar device, it receives the radar signal from the controllable oscillator and outputs it for emission by the antenna, receives the radar signal received by the antenna and outputs it to the mixer and minimizes a direct output of the radar signal from the controllable oscillator to the mixer.

5. The radar device according to claim 1, wherein between an input receiving the radar signal from the controllable oscillator and an output outputting the radar signal to the mixer, the circulator has an isolation of at least −38 dB.

6. The radar device according to claim 1, wherein the circulator is a dual circulator.

7. The radar device according to claim 1, wherein the transmitter antenna or the receiver antenna has an S11 parameter of −10 dB or less, over the entire tuning bandwidth of the controllable oscillator or over a whole-number multiple of the tuning bandwidth.

8. The radar device according to claim 1, wherein it has a first and a second mixer and a phase shifter, wherein the first mixer is configured and arranged such that, during operation of the radar device, it receives the radar signal from the oscillator and the radar signal received by the receiver antenna or the signal which was produced from the signal received by the receiver antenna by frequency division, mixes the signals with each other and produces and outputs a first intermediate frequency signal, wherein the phase shifter is configured and arranged such that, during operation of the radar device, it receives the radar signal from the controllable oscillator, introduces a phase shift of 90°between the radar signal received by the first mixer from the controllable oscillator and the radar signal received by the second mixer from the controllable oscillator and produces and outputs a phase-shifted radar signal, and wherein the second mixer is configured and arranged such that, during operation of the radar device, it receives the phase-shifted radar signal from the phase shifter and the radar signal received by the receiver antenna or the signal which was produced from the signal received by the receiver antenna by frequency division, mixes the signals with each other and outputs a second intermediate frequency signal, and wherein the evaluator is configured and arranged such that, during operation of the radar device, it receives the first and the second intermediate frequency signal from the first and the second mixer, evaluates them and determines a distance between an object that can be arranged in a beam path of the radar signal or the signal produced from the radar signal between the transmitter antenna and the receiver antenna and reflects the radar signal or the signal produced from the radar signal and the transmitter antenna or the receiver antenna.

9. The radar device according to claim 1, wherein it has a filter, wherein the filter is configured and arranged such that it receives the intermediate frequency signal from the mixer and outputs a filtered intermediate frequency signal.

10. The radar device according to claim 1, wherein the filter is a bandpass filter, which is configured such that it filters a direct-current voltage portion and higher-frequency repeating spectra out of the intermediate frequency signal.

11. The radar device according to claim 1, wherein it has an amplifier, wherein the amplifier is configured and arranged such that it receives the intermediate frequency signal from the mixer and outputs an amplified intermediate frequency signal and/or in that the evaluator has an analogue-to-digital converter, which is configured and arranged such that it converts the intermediate frequency signal into a digital signal for further digital processing, wherein the analogue-to-digital converter has a bit depth of at least 14 bits, preferably of at least 16 bits.

12. The radar device according to claim 1, wherein the evaluator is configured such that, to determine the frequency of the intermediate frequency signal, it applies a Fourier transform to the intermediate frequency signal.

13. The radar device according to claim 1, wherein the evaluator is configured such that it evaluates the phase values of the Fourier transforms.

14. Use of a radar device according to claim 1 for determining a distance of a moving part from a stationary housing, wherein the moving part is received in the housing and wherein an element of the radar device is arranged in the housing.

15. Use of a radar device according to claim 1, wherein the moving part is a rotor, wherein the distance between the rotor and the housing is the radial extent of a gap between the rotor and the housing.
